(19) United States
(12) Patent Application Publication
(10) Pub. No.: US 2013/0052863 A1
(43) Pub. Date: Feb. 28, 2013

(54) CABLE CONNECTOR

(71) Applicant: Ching-Yang CHIU, Taipei City (TW)

(72) Inventor: Ching-Yang CHIU, Taipei City (TW)

(21) Appl. No.: 13/314,386

(22) Filed: Dec. 8, 2011

(30) Foreign Application Priority Data
Aug. 25, 2011 (TW) 100215871

(51) Int. Cl. H01R 9/05

(52) U.S. Cl. 439/585

(57) ABSTRACT

A cable connector including a metal terminal having a middle section configured for clamping a center conductor of a coaxial cable, an insulating seat including two positioning seats that are integrally formed by injection molding and have the same configuration, and a metal housing integrally formed by stamping. The positioning seats are assembled together to completely enclose the metal terminal fitted therein. Portions of the metal housing corresponding to the insulating seat, and a shield layer and a jacket of the coaxial cable can be wrapped around and secured to the peripheries of the insulating seat, the shield layer, and the jacket respectively. Thus, the simple configuration of the insulating seat not only increases the assembly efficiency of the cable connector, but also minimizes wall thickness of the insulating seat for allowing the cable connector to be used in various compact mobile electronic devices.

### FIELD OF THE INVENTION

The present invention relates to a cable connector, more particularly to a cable connector having an insulating seat, wherein the insulating seat includes two positioning seats that have the same configuration. Since the two positioning seats are integrally formed by injection molding and are connected at one end thereof, the simple configuration of the insulating seat increases not only the assembly efficiency of the cable connector, but also the yield rate of the cable connector during the injection molding process. Further more, the wall thickness of the insulating seat can also be minimized, thus allowing the cable connector to be used in various compact mobile electronic devices.

### BACKGROUND OF THE INVENTION

Connectors for enabling electrical connection and signal transmission between elements, devices, or systems are widely used in various electronic systems and are essential to system construction. Typically, the components of such a connector are individually designed and manufactured, before they are put together to form the connector. This component-based approach not only allows highly flexible component modularization but also saves design and production costs. However, due to technical limitations and cost considerations, it is practically infeasible to design automatic assembly machines specifically for connectors of different specifications. Instead, connectors are often manually assembled to facilitate flexible production line management and to better cope with the changing demand quantities of connectors of different specifications, In order to meet the current design trend toward—or consumer preference for—increasingly smaller and lighter mobile electronic devices, the industry has spared no effort in improving and miniaturizing commercially available connectors. Besides structural strength and electrical connectivity, factors that must be considered when making such improvements include the convenience of assembly and product yield rate, both of which are critical to production cost reduction. Therefore, it is an important issue in the industry to develop connectors that are improved in all the aforesaid aspects.

Please refer to FIG. 1 for a sectional view of a conventional cable connector 1. The cable connector 1 includes a connection terminal 11, an insulating seat 12, and a metal housing 13. The connection terminal 11 is provided at one end of a coaxial cable 10 and electrically connected to the coaxial cable 10. The insulating seat 12 is generally L-shaped and has an insertion/connection portion 120 at one end. The insertion/connection portion 120 corresponds in configuration to the connection terminal 11 so that the connection terminal 11 can be inserted into the insertion/connection portion 120. The insulating seat 12 has another end extending outward to form a first positioning portion 121. After the connection terminal 11 is inserted into the insertion/connection portion 120, the first positioning portion 121 is folded toward the coaxial cable 10 until the first positioning portion 121 lies against the aforesaid end of the coaxial cable 10. The metal housing 13 is also generally L-shaped and has one end formed with a receiving cavity 130, wherein the receiving cavity 130 has one end (e.g., the upper end as shown in FIG. 1) corresponding in configuration to the insertion/connection portion 120. The insertion/connection portion 120 is inserted into this end of the receiving cavity 130 and thus secured in the receiving cavity 130. The metal housing 13 has another end extending outward to form a second positioning portion 131, and the second positioning portion 131 is provided with at least one positioning plate 131a. Both the second positioning portion 131 and the at least one positioning plate 131a are folded toward the coaxial cable 10 and wrapped around a portion of the coaxial cable 10 that is proximate to the aforesaid end thereof, thereby completing the assembly of the cable connector 1. A user only has to insert a cable plug (not shown) into the other end (e.g., the lower end as shown in FIG. 1) of the receiving cavity 130, and the cable plug is positioned in the insertion/connection portion 120, coupled to the connection terminal 11, and hence electrically connected to the coaxial cable 10 for signal transmission.

The cable connector 1, though capable of electrically connecting the cable plug and the coaxial cable 10, still leaves much room for improvement, particularly in terms of manufacture, as detailed below:

(1) Bulkiness: The insulating seat 12 of the cable connector 1 is made by an injection molding process. Due to the distances between the two ends and the middle bent portion of the L-shaped insulating seat 12, the wall of the insulating seat 12 must not be too thin, or molten plastic may have problem flowing evenly into the mold during the injection molding process, in which case the quality and yield rate of the insulating seat 12 will be impaired. However, if the wall thickness of the insulating seat 12 is increased, the overall volume of the cable connector 1 and the space occupied thereby will increase, too, making the cable connector 1 unsuitable for use in today's more and more compact mobile electronic devices (e.g., smart phones, tablet PCs, etc.).

(2) Insufficient connection stability: Once the aforesaid end of the coaxial cable 10 and the connection terminal 11 are received in the insulating seat 12, and the positioning portions 121, 131 are folded to connect the cable connector 1 to the end of the coaxial cable 10, the cable connector 1 is merely pressed against and wrapped around the end of the coaxial cable 10 by means of the first positioning portion 121 and the second positioning portion 131, but is not tightly secured to the end of the coaxial cable 10. Should the coaxial cable 10 or the cable connector 1 be subjected to an external force, the cable plug is very likely to come off the connection terminal 11, or signal transmission through the cable connector 1 may become instable.

(3) Insufficient plug/unplug durability: Referring to FIG. 1, as it is common practice nowadays to form the metal housing 13 of the cable connector 1 by curling its two lateral sides toward each other, the edge of the metal housing 13 that is located at the lower end of receiving cavity 130 does not make a complete circle but a circle with a gap. Therefore, after the cable plug is plugged into and unplugged from the receiving cavity 130 for many times, the gapped lower end of the receiving cavity 130 will gradually loosen such that the cable connector 1 can no longer sustain the plugging and unplugging forces of the cable plug.

Hence, the issue to be addressed by the present invention is to design a cable connector which can be securely positioned at one end of a coaxial cable and whose insulating seat has a wall thickness that is not subject to injection molding limitations, so as for the cable connector to have a high yield rate and a compact size suitable for use in various mobile electronic devices.

### BRIEF SUMMARY OF THE INVENTION

In view of the fact that the conventional cable connectors have an overly complicated insulating seat that not only hinders plastic injection in the injection molding process but also prevents the connectors from being downsized, the inventor of the present invention incorporated years of practical experience into extensive research and experiment and finally succeeded in developing a cable connector that solves the various design and production problems of its prior art counterparts.

It is an object of the present invention to provide a cable connector which includes a metal terminal, an insulating seat, and a metal housing. The metal terminal has a middle section configured for clamping one end of the center conductor of a coaxial cable. The insulating seat includes two positioning seats that have the same configuration. The two positioning seats are integrally formed by injection molding and are connected at one end. Each positioning seat has one lateral side that is concavely provided with a positioning groove, and each positioning groove corresponds in configuration to the insulating layer at one end of the coaxial cable and the metal terminal. The positioning seats are assembled together to form the insulating seat, with both the insulating layer and the metal terminal fitted in the positioning grooves and completely enclosed in the assembled insulating seat. Each positioning seat has a projecting portion that is laterally formed with a recess, wherein the recess is in communication with the corresponding positioning groove. Also, the cross-sectional shape of each recess matches that of either of the two end portions of the metal terminal. Thus, when the insulating layer and the metal terminal are completely enclosed in the insulating seat, the two projecting portions jointly form an insertion portion, and the two recesses jointly form an insertion hole in which both end portions of the metal terminal are inserted and secured. The metal housing is integrally formed by stamping and has a receiving hole. The receiving hole corresponds in configuration to the insertion portion, so as for the insertion portion to pass through the receiving hole and be exposed on the metal housing. The metal housing itself corresponds in configuration to the insulating seat and to the shield layer and the jacket at the aforesaid end of the coaxial cable. Those portions of the metal housing that correspond to the insulating seat, the shield layer, and the jacket can be folded in such a way that they are wrapped around and secured to the peripheries of the insulating seat, the shield layer, and the jacket respectively. Thus, when a cable plug is inserted into the insertion portion, the center conductor of the cable plug passes through the insertion hole and is clamped by the two end portions of the metal terminal to enable electrical connection and hence signal transmission between the center conductor of the coaxial cable and the center conductor of the cable plug. The simple configurations of the insulating seat and of the metal housing increase not only the assembly efficiency of the cable connector but also the yield rate of the cable connector during the injection molding process. The wall thickness of the insulating seat can also be minimized, thus allowing the cable connector to be used in various compact mobile electronic devices.

It is another object of the present invention to provide the foregoing cable connector, wherein the metal housing includes a main plate and a plurality of assembly plates, and wherein the receiving hole is integrally formed on the main plate by stamping. Once the insertion portion is inserted in the receiving hole, the main plate lies against a portion of the insulating seat that corresponds in position to the insertion portion. On the other hand, the assembly plates are sequentially connected to one end of the main plate and correspond in configuration to the surface of the insulating seat. When the main plate is positioned on the insulating seat, the assembly plates can be folded toward and wrapped around the insulating seat to form the metal housing. Thus, it is ensured that the metal housing lies firmly on the insulating seat and is secured thereto to enhance the connection stability and structural strength of the cable connector.

### BRIEF DESCRIPTION OF THE SEVERAL VIEWS OF THE DRAWINGS

The structure as well as a preferred mode of use, further objects, and advantages of the present invention will be best understood by referring to the following detailed description of an illustrative embodiment in conjunction with the accompanying drawings, in which:

FIG. 1 is a schematic drawing of a conventional cable connector;

FIG. 2 is a partial perspective view of a cable connector in accordance with the present invention;

FIG. 3 is another partial perspective view of the cable connector in accordance with the present invention;

FIG. 4 is a perspective view of a metal housing of the cable connector in accordance with the present invention;

FIG. 5A is a perspective view showing the assembly process of the cable connector in accordance with the present invention;

FIG. 5B is another perspective view showing the assembly process of the cable connector in accordance with the present invention; and

FIG. 5C is yet another perspective view showing the assembly process of the cable connector in accordance with the present invention.

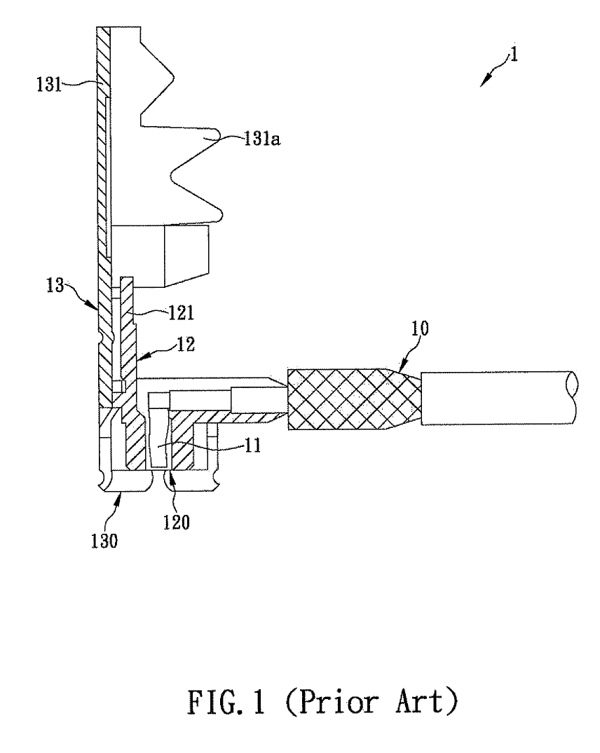

### DETAILED DESCRIPTION OF THE INVENTION

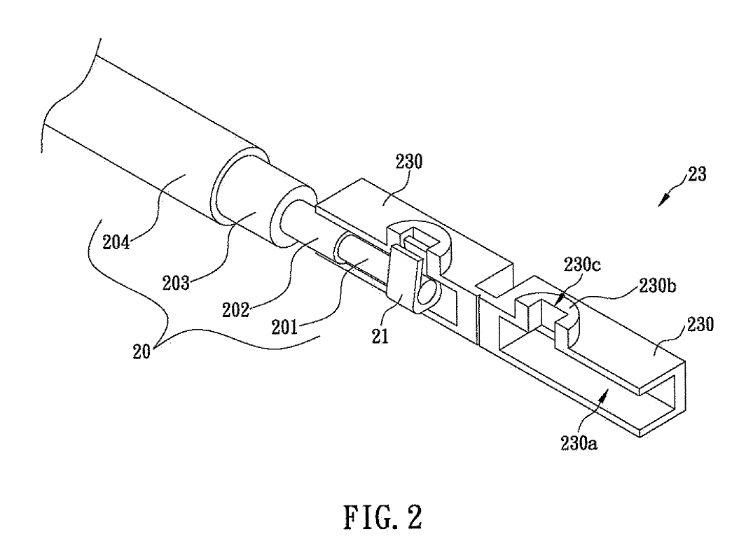

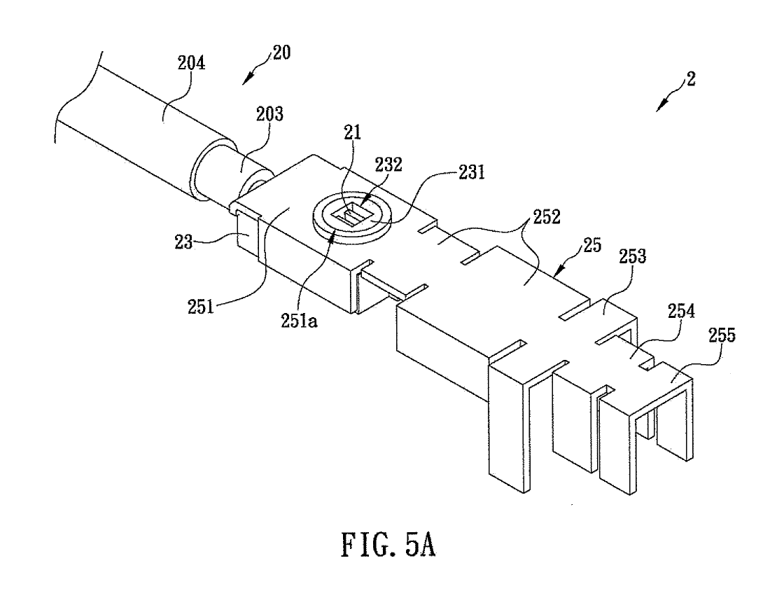

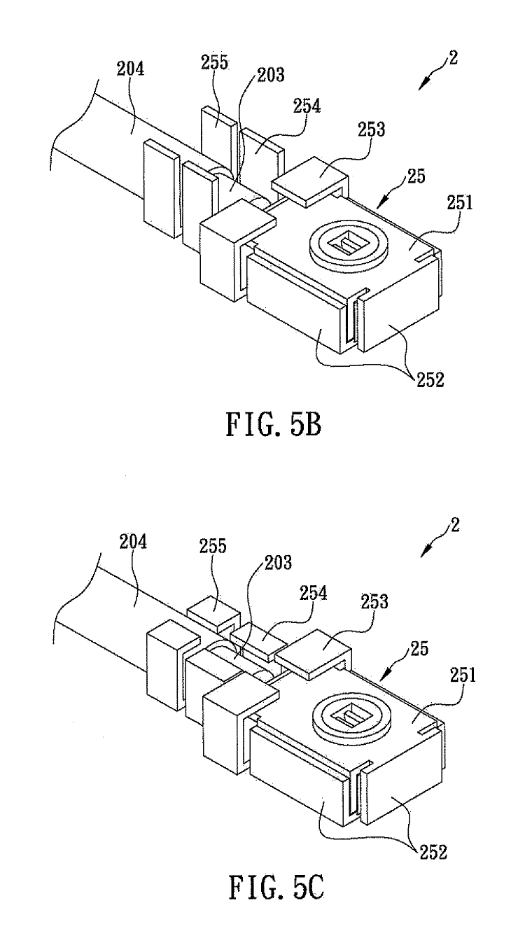

The present invention discloses a cable connector. Referring to FIGS. 2 and 5A, a cable connector 2 in accordance with the present invention is connected to a coaxial cable 20 that includes, in order from inside out, a center conductor 201, an insulating layer 202, a shield layer 203, and a jacket 204. The insulating layer 202 encloses the center conductor 201 to insulate the center conductor 201 from other conductors. The shield layer 203 covers the insulating layer 202 and has a grounding function to prevent the center conductor 201 from being affected by electronic noises and crosstalk. The jacket 204 is wrapped around the shield layer 203 to protect the shied layer 203 from wear and tear. On the other hand, the cable connector 2 includes a metal terminal 21, an insulating seat 23, and a metal housing 25. The metal terminal 21 is U-shaped and corresponds in configuration to the center conductor 201 at one end of the coaxial cable 20. More particularly, the middle section of the metal terminal 21 is configured for clamping the center conductor 201 and thereby making electrical connection with the coaxial cable 20.

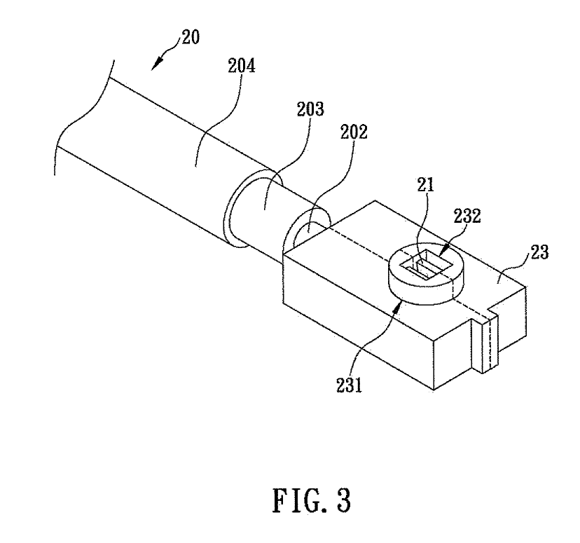

As shown in FIG. 2, the insulating seat 23 includes two positioning seats 230 that have the same configuration. The two positioning seats 230 are connected at one end and are made by an injection molding process as a single piece. Each positioning seat 230 is laterally formed with a positioning groove 230a, and each positioning groove 230a corresponds in configuration to the insulating layer 202 at the aforesaid end of the coaxial cable 20 and the metal terminal 21. Thus, a portion of the center conductor 201 and a portion of the metal terminal 21 can be fitted into either of the positioning grooves 230a from one lateral side of the connected and juxtaposed positioning seats 230. Referring to FIGS. 2 and 3, after the insulating layer 202 at the aforesaid end of the coaxial cable 20 and the metal terminal 21 are partially inserted into the positioning groove 230a of one positioning seat 230 (say, the first positioning seat 230), the other positioning seat 230 (say, the second positioning seat 230) is folded toward the first positioning seat 230 until the two positioning seats 230 are pressed against each other along one lateral side, thereby bringing the two positioning grooves 230a into communication. As a result, the insulating seat 23 is formed, and the insulating layer 202 at the aforesaid end of the coaxial cable 20 and the metal terminal 21 are received in the positioning grooves 230a. Each positioning seat 230 further has a projecting portion 230b, wherein the projecting portion 230b is laterally formed with a recess 230c communicating with the corresponding positioning groove 230a. In addition, the cross-sectional configuration of each recess 230c corresponds to that of either of the two end portions of the metal terminal 21. Therefore, once the positioning seats 230 are assembled together to form the insulating seat 23, the projecting portions 230b form an insertion portion 231, and the recesses 230c form an insertion hole 232 for receiving the two end portions of the metal terminal 21.

It should be pointed out that, after the positioning seats 230 are folded into the insulating seat 23, the joining surfaces of the positioning seats 230 can be connected by a high-frequency sealing process or a gluing process to ensure structural stability of the insulating seat 23.

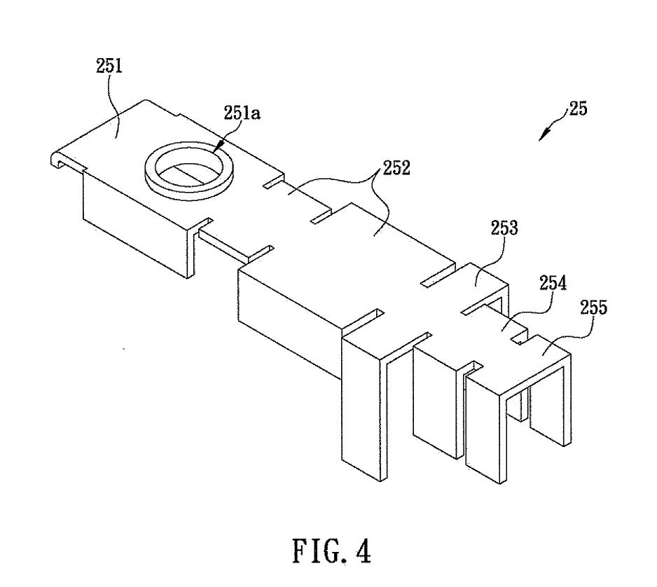

Reference is now made to FIGS. 4 and 5A. The metal housing 25 is integrally formed by a stamping process and includes a main plate 251, a plurality of first assembly plates 252, and at least one second assembly plate 253. The main plate 251 has a U-shaped configuration and is formed with a receiving hole 251a in the middle section. The receiving hole 251a corresponds in configuration to the insertion portion 231 so that the insertion portion 231 can be inserted into the receiving hole 251a, thereby exposing both the insertion portion 231 and the insertion hole 232 through the receiving hole 251a. In addition, while the insertion portion 231 is in the receiving hole 251a, the main plate 251 lies against and is secured to a portion of the insulating seat 23 that corresponds in position to the insertion portion 231. The first assembly plates 252, which are sequentially connected to one end of the main plate 251 and correspond in configuration to the insulating seat 23, can be folded against the surface of the main plate 251 and the surface of the insulating seat 23 respectively, thereby wrapping and securing the insulating seat 23. The second assembly plate 253 is connected to the first assembly plates 252 and corresponds in configuration to the main plate 251. Once the first assembly plates 252 are wrapped around the insulating seat 23, the second assembly plate 253 can be folded in such a way that the two opposite ends thereof lie against and are secured to an opposite end of the main plate 251. This is to ensure that the main plate 251 and the first assembly plates 252 are wrapped firmly around the surface of the insulating seat 23 to form the metal housing 25.

Referring to FIGS. 5A to 5C, the metal housing 25 in a preferred embodiment of the present invention further includes at least one first positioning plate 254 and at least one second positioning plate 255. As shown in the drawings, the first positioning plate 254 is connected to the second assembly plate 253 and corresponds in configuration to the shield layer 203 at the aforesaid end of the coaxial cable 20. Therefore, after the main plate 251 and the assembly plates 252, 253 are folded to form the metal housing 25, the first positioning plate 254 is positioned adjacent to the shield layer 203 at the aforesaid end of the coaxial cable 20 (see FIG. 5B). The first positioning plate 254 is further folded to clamp the shield layer 203 and be secured thereto (see FIG. 5C). The second positioning plate 255, on the other hand, is connected to the second assembly plate 253 either directly or indirectly (e.g., the second positioning plate 255 in this embodiment being connected to the second assembly plate 253 via the first positioning plate 254) and corresponds in configuration to the jacket 204 at the aforesaid end of the coaxial cable 20. Once the assembly plates 252, 253 are folded into the metal housing 25, the second positioning plate 255 is positioned adjacent to the jacket 204 at the aforesaid end of the coaxial cable 20 (see FIG. 5B). The second positioning plate 255 is subsequently folded to clamp the jacket 204 and be secured to the periphery thereof (see FIG. 5C). Thus, the metal housing 25 is firmly positioned at the aforesaid end of the coaxial cable 20, and the assembly process of the cable connector 2 is completed. When a cable plug (not shown) is inserted into the insertion portion 231, the center conductor of the cable plug passes through the insertion hole 232 and is clamped by the two end portions of the metal terminal 21. As a result, the center conductor of the cable plug is electrically connected to the coaxial cable 20 to enable data transmission.

As shown in FIGS. 2 to 4, the simple configuration of the positioning seats 230 allows molten plastic to fill up the mold of the positioning seats 230 during the injection molding process, thereby preventing uneven formation and substantially increasing the yield rate of the insulating seat 23. The configuration of the positioning seats 230 also allows a more compact design so that the cable connector 2 can be used in different mobile electronic devices without taking up too much space or making such devices bulky. Furthermore, due to the simple structures and easy assembly procedure of the insulating seat 23 and the metal housing 25, the assembly efficiency of the cable connector 2 can be effectively enhanced. With the metal housing 25 clamping the insulating layer 202, the shield layer 203, and the jacket 204 at the aforesaid end of the coaxial cable 20 individually, the stability of connection between the cable connector 2 and the coaxial cable 20 is also effectively increased to assure signal transmission quality of the cable connector 2. In addition, as the receiving hole 251a is integrally formed on the metal housing 25 by stamping, it can be a complete circle to ensure both structural stability and plug/unplug durability. Even if the cable plug has been plugged into and unplugged from the insertion portion 231 via the receiving hole 251a for many times, the cable plug can still be securely connected to the cable connector 2.

While the invention herein disclosed has been described by means of specific embodiments, numerous modifications and variations could be made thereto by those skilled in the art without departing from the scope of the invention set forth in the claims.

What is claimed is:

1. A cable connector, comprising:
a metal terminal having a U-shaped configuration for clamping a center conductor at an end of a coaxial cable;
an insulating seat comprising two positioning seats of a same configuration, wherein the positioning seats are integrally formed by injection molding and each have a lateral side formed with a positioning groove corresponding in configuration to an insulating layer at the end of the coaxial cable and the metal terminal, the positioning seats being assembled together in such a way that, while the positioning seats form the insulating seat, the insulating layer at the end of the coaxial cable and the metal terminal are enclosed in the positioning grooves, each said positioning seat having another lateral side protrudingly provided with a projecting portion, each said projecting portion having a recess in communication with a corresponding said positioning groove, each said recess corresponding in cross-sectional configuration to the metal terminal so that, once the insulating layer of the coaxial cable and the metal terminal are enclosed in the insulating seat, the projecting portions form an insertion portion, and the recesses form an insertion hole in which two end portions of the metal terminal are positioned; and
a metal housing integrally formed by stamping, the metal housing having a receiving hole corresponding in configuration to the insertion portion, thus allowing the insertion portion to pass through the receiving hole and be exposed on the metal housing, the metal housing corresponding in configuration to the insulating seat and a shield layer and a jacket at the end of the coaxial cable and being folded in such a way that portions of the metal housing that correspond to the insulating seat, the shield layer, and the jacket are secured to the insulating seat, the shield layer, and the jacket respectively.

2. The cable connector of claim 1, wherein the metal housing comprises a main plate having a U-shaped configuration, and the receiving hole is formed on the main plate so that, once the insertion portion is inserted in the receiving hole, the main plate lies against a portion of the insulating seat that corresponds in position to the insertion portion.

3. The cable connector of claim 2, wherein the metal housing further comprises a plurality of first assembly plates and at least a second assembly plate, the first assembly plates being sequentially connected to the main plate and corresponding in configuration to the insulating seat so that, once the first assembly plates are sequentially folded toward the insulating seat, the main plate and the first assembly plates can be wrapped around the insulating seat, the at least a second assembly plate being connected to the first assembly plates and foldable in such a way that two opposite ends of each said second assembly plate lie against and are secured to the main plate.

4. The cable connector of claim 3, wherein the metal housing further comprises at least a first positioning plate connected to the at least a second assembly plate so that, once the main plate and the first assembly plates are wrapped around the insulating seat, the at least a first positioning plate is foldable toward the shield layer at the end of the coaxial cable so as to clamp and be secured to the shield layer.

5. The cable connector of claim 3, wherein the metal housing further comprises at least a second positioning plate directly or indirectly connected to the at least a second assembly plate so that, once the main plate and the first assembly plates are wrapped around the insulating seat, the at least a second positioning plate is foldable toward the jacket at the end of the coaxial cable so as to clamp and be secured to the jacket.

6. The cable connector of claim 4, wherein the metal housing further comprises at least a second positioning plate directly or indirectly connected to the at least a second assembly plate so that, once the main plate and the first assembly plates are wrapped around the insulating seat, the at least a second positioning plate is foldable toward the jacket at the end of the coaxial cable so as to clamp and be secured to the jacket.

7. A cable connector, comprising:
a metal terminal having a U-shaped configuration for clamping a center conductor at an end of a coaxial cable;
an insulating seat for enclosing an insulating layer at the end of the coaxial cable and the metal terminal, the insulating seat having a lateral side protrudingly provided with an insertion portion corresponding in configuration to the metal terminal so that two end portions of the metal terminal can be positioned in an insertion hole of the insertion portion; and
a metal housing integrally formed by stamping, the metal housing having a receiving hole, the receiving hole forming a complete circle and corresponding in configuration to the insertion portion, thus allowing the insertion portion to pass through the receiving hole and be exposed on the metal housing, the metal housing corresponding in configuration to the insulating seat and a shield layer and a jacket at the end of the coaxial cable and being folded in such a way that portions of the metal housing that correspond to the insulating seat, the shield layer, and the jacket are secured to the insulating seat, the shield layer, and the jacket respectively.

8. The cable connector of claim 7, wherein the metal housing comprises a main plate having a U-shaped configuration, and the receiving hole is formed on the main plate so that, once the insertion portion is inserted in the receiving hole, the main plate lies against a portion of the insulating seat that corresponds in position to the insertion portion.

9. The cable connector of claim 8, wherein the metal housing further comprises a plurality of first assembly plates and at least a second assembly plate, the first assembly plates being sequentially connected to the main plate and corresponding in configuration to the insulating seat so that, once the first assembly plates are sequentially folded toward the insulating seat, the main plate and the first assembly plates can be wrapped around the insulating seat, the at least a second assembly plate being connected to the first assembly plates and foldable in such a way that two opposite ends of each said second assembly plate lie against and are secured to the main plate.

10. The cable connector of claim 9, wherein the metal housing further comprises at least a first positioning plate connected to the at least a second assembly plate so that, once the main plate and the first assembly plates are wrapped around the insulating seat, the at least a first positioning plate is foldable toward the shield layer at the end of the coaxial cable so as to clamp and be secured to the shield layer.

11. The cable connector of claim 9, wherein the metal housing further comprises at least a second positioning plate directly or indirectly connected to the at least a second assembly plate so that, once the main plate and the first assembly plates are wrapped around the insulating seat, the at least a second positioning plate is foldable toward the jacket at the end of the coaxial cable so as to clamp and be secured to the jacket.

12. The cable connector of claim 10, wherein the metal housing further comprises at least a second positioning plate directly or indirectly connected to the at least a second assembly plate so that, once the main plate and the first assembly plates are wrapped around the insulating seat, the at least a second positioning plate is foldable toward the jacket at the end of the coaxial cable so as to clamp and be secured to the jacket.
